(19) United States
(12) Patent Application Publication
(10) Pub. No.: US 2006/0163870 A1
(43) Pub. Date: Jul. 27, 2006

(54) Pneumatic joint

(75) Inventor: Frederic Goilot, Rennes (FR)

Correspondence Address: YOUNG & THOMPSON, 745 SOUTH 23RD STREET, 2ND FLOOR, ARLINGTON, VA, 22202, US

(73) Assignee: LEGRIS SA, RENNES (FR)

(21) Appl. No.: 10/540,996

(22) PCT Filed: Dec. 19, 2003
(86) PCT No.: PCT/FR03/03806

§ 371 Date: Jun. 28, 2005

(30) Foreign Application Priority Data
Dec. 30, 2002 (FR) 0216839

(51) Int. Cl. F16L 41/00; F16L 27/00

(52) U.S. Cl. 285/143.1

(57) ABSTRACT

The invention concerns the assembly of a first pneumatic element (1), comprising a hollow screw (3) with a longitudinal axis (3a), and a second pneumatic element (2) provided with a tapped orifice (2a) for receiving the hollow screw (2) such that a first shoulder (5) of the hollow screw is designed to press on the edge (6) of the tapped orifice (2a) an O-ring (7), while the first element (1) comprises, opposite the thread, a bearing surface (8), axially limited by a second shoulder (11), for guiding and retaining a tubular spacer (9) slidably mounted on said bearing surface between a first position wherein it extends beyond the first shoulder (5) on the thread side and a second position wherein it is in contact with the second shoulder (11), the spacer comprising means (9a, 12) indicating the clamping tension provided or to be provided in the hollow screw (3).

The present invention relates to means for making a connection between two pneumatic members such as a coupling fixed to the end of a duct and a member making use of pneumatic energy, such as a drill, a dispenser,

### BACKGROUND OF THE INVENTION

In the field of pneumatic couplings, in particular screw couplings, it is desired to replace metal parts with parts made of plastics material for reasons of expense: it is less expensive to make the externally threaded hollow screw by injection molding a thermoplastic material having a mineral fiber fill than it is by using a screw machine. However, with that method of manufacture in which the threaded portion is unmolded by being unscrewed, it is not possible to make a groove between the thread of the hollow screw and the head (or bearing shoulder) of the screw, where such a groove is used for receiving an O-ring. It is then appropriate to house the O-ring in an annular groove formed in the surface of the shoulder, thus requiring, other things remaining equal, the size of the coupling to be increased in its portion beyond the shoulder.

In addition, a member for screw-tightening and made of a plastics material cannot withstand the tightening torque usually exerted on metal parts of the same dimensions.

Finally, the geometrical qualities of the threaded portion obtained by injection molding are much less precise than those of a metal part made using a screw machine; in particular a molded part is often ovalized and the torque that needs to be developed in order to achieve tightening is greater than that normally expected by an operator, who is then tempted to cease tightening before leaktightness has been achieved. The coupling is then defective and leaks.

### OBJECT OF THE INVENTION

The present invention proposes a pneumatic junction structure suitable for being manufactured by injection molding, but in which the above-mentioned drawbacks are avoided.

### BRIEF SUMMARY OF THE INVENTION

To this end, the invention provides a junction between a first pneumatic element having a hollow screw with a longitudinal axis and a second pneumatic element provided with a tapped orifice for receiving the hollow screw, a first shoulder of the hollow screw being designed to bear against the edge of the tapped orifice via an O-ring, in which the first element includes, remote from the thread, a bearing surface for guidance and holding purposes that is defined axially by a second shoulder, a tubular spacer being slidably mounted on said bearing surface to be move between a first position in which it extends beyond the first shoulder beside the thread, and a second position in which it is in contact with the second shoulder, the spacer including means for indicating the tightening tension that has been established or that is to be established in the hollow screw.

In the first position of the spacer, it constitutes means for holding and protecting an O-ring placed beneath the shoulder, without being housed in a groove in the hollow screw. In the second position of the spacer, it constitutes a body that is subjected to the tightening force, and that is thus deformed under said force, with said deformation serving as a force indicator that is useful for governing the intensity of tightening either before it is applied (e.g. by indicating the starting point of a determined angular stroke), or while it is being applied (by indicating when a deformation of threshold is reached).

In a particular embodiment of the invention, the bearing surface possesses a peripheral portion in relief and the spacer possesses at least one portion that is displaceable on going past the portion in relief, in such a manner that said displacement occurs suddenly and constitutes a visual signal for the operator or generates an audible signal for the operator (e.g. a click noise), either at the beginning of tightening that is to be performed over a determined amplitude, or else at the end of such tightening.

The ability of said wall portion to be displaced can be obtained by means of elasticity, said wall portion being designed as a resilient pawl or tongue, or by means of a break starter formed in the base of a tooth and causing the tooth to be ejected on going past the portion in relief.

Preferably, between the second shoulder and the edge of the tapped orifice, the spacer possesses a zone for flattening when it is compressed axially, said flattening zone being constituted by portions in relief at the end of the spacer.

In a variant embodiment, the material of the hollow screw and that of the spacer are selected in such a manner that one of the axial ends of the spacer is provided with teeth suitable for penetrating into the second shoulder.

Finally, mention can be made of another variant embodiment of the invention in which the spacer is transparent or translucent.

Other characteristics and advantages of the invention appear from the description given below by way of example relating to a few variant embodiments of the invention.

### BRIEF DESCRIPTION OF THE DRAWING

Reference is made to the accompanying drawing, in which:

FIG. 1 is an outside view, partially in section, showing a first embodiment of the invention with the spacer in its first position;

FIG. 2 is a view similar to that of FIG. 1, with the spacer being shown in its second position;

FIG. 3 is an outside view of the spacer implemented in the above figures;

FIG. 4 is a view similar to that of FIGS. 1 and 2 showing a variant embodiment of the junction of the invention; and

FIG. 5 is a section view of another variant embodiment of the junction of the invention.

### DETAILED DESCRIPTION OF THE INVENTION

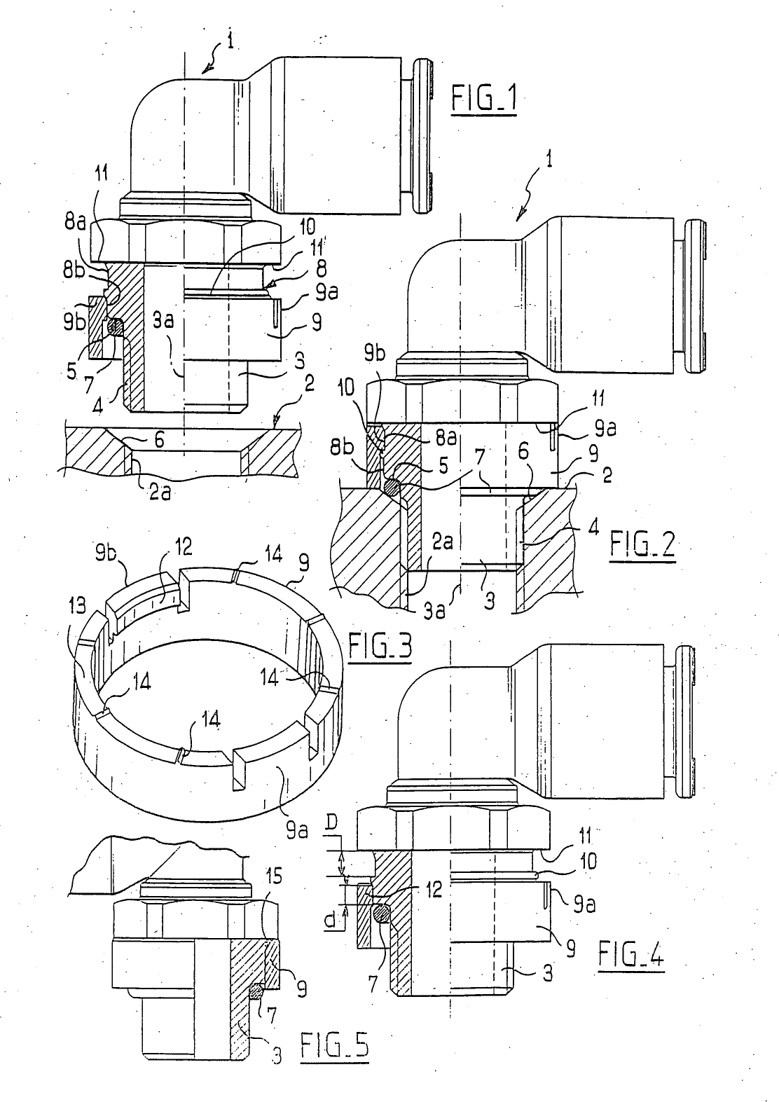

FIGS. 1 and 2 show a pneumatic junction in the form of an angle coupling 1 of well-known type, for screwing into the tapped orifice 2a of a pneumatic body, such as an actuator, for example. The coupling comprises a hollow screw 3 of axis 3a and having a thread 4 formed under a shoulder 5 via which the coupling bears against the edge 6 of the tapped orifice 2a, via an O-ring 7.

At the end of the shoulder 5 remote from the thread, the hollow screw 3 is extended by a bearing surface 8 for holding and guiding a tubular spacer 9. The spacer is shown in FIG. 1 in a first position in which it has a portion extending beyond the shoulder 5 so as to form a protective screen for the O-ring 7. The spacer is held in this position either by its portion 9a being a tight fit on the bearing surface 8, or by being weakly bonded thereto by adhesive. This adhesive or tight fit, in association with the bead described below, constitutes temporary connection means for axially indexing the position of the spacer relative to the bearing surface 8.

It should be observed that the bearing surface 8 is subdivided into two sections 8a and 8b by a bead 10, with the section 8a forming a zone for receiving the spacer 9 after it has gone from its first position as shown in FIG. 1 to its second position as shown in FIG. 2 under axial thrust generated by screwing the screw 3 into the orifice 2a, with the spacer then bearing against the part 2. The section 8a of the bearing surface 8 is terminated remote from the bead 10 by a shoulder 11 against which the spacer 9 comes into abutment.

FIG. 3 is an outside view of the spacer 9 implemented in the above figures. It can be seen that this spacer is a cylindrical body having two portions 9a and 9b (although one alone would suffice) forming resilient tongues, each having a free end provided with a kind of inwardly-directed radial to the 12. It is these teeth that bear against the section 8b of the bearing surface 8 while the spacer is in its first position and against the section 8a, behind the bead 10, once the spacer 9 is in its second position. Furthermore, on its end 13 facing towards the shoulder 11, the spacer 9 possesses portions in relief 14 constituting elements that are suitable for being flattened by the shoulder when the coupling continues to be screwed into the orifice 2a.

The axial dimension of the teeth 12 is such that after the portions in relief 14 have been flattened to a certain extent, the teeth that have been urged resiliently outwards by the bead 10 snap suddenly against the section 8a of the bearing surface 8, making a “click” noise that is perceived by the operator as an indication that screw tightening has reached a threshold that is satisfactory firstly for achieving leaktight contact by means of the O-ring 7 being pinched between the shoulder 5 and the surface 6 of the edge of the orifice 2a, and secondly for establishing sufficient tightening tension in the hollow screw 3, i.e. tension that is compatible with the mechanical characteristics of the plastics material constituting the screw. The final position reached by the spacer 9 is shown in FIG. 2, where elements as described above are given the same references.

In a variant of the invention that is not shown, instead of a bead 10, it is possible to provide a step between the sections 8a and 8b of the bearing surface 8 so that the section 8a is of smaller diameter than the section 8b. Under such circumstances, the teeth 12 are bent outwards by the section 8b and on going past the reduction in diameter they return elastically and suddenly against the section 8a, thus issuing the “click”.

The invention also covers the variant embodiment in which the portions in relief 14 are not flattened, but bite into the surface of the shoulder 11, with the materials of the screw and of the spacer being of different hardnesses in order to achieve this effect. This biting produces the additional effect of impeding unscrewing of the coupling, providing, naturally, the spacer is provided at its other end with portions in relief for biting into the element 2.

In FIG. 4, the spacer shown differs from that described above by the fact that it does not have portions in relief 14, and the axial dimension d of the teeth 12 is less than an accurately determined value of axial dimension D of the section 8a of the bearing surface 8 situated above the bead 10. Under such circumstances, the operator hears the teeth 12 “click” against the bearing surface 8 while tightening the screw at a moment when the critical tightening value has still not been reached. However, the operator then knows that from this moment it suffices to drive the hollow screw through an additional angle of predetermined amplitude in order to reach the required tightening threshold.

In a variant of the invention that is not shown, the teeth 12 are of an axial dimension such that their frictional contact against the bead 10 leads to bending and breakage. It is this breakage or ejection that then constitutes the signal for the operator, instead of and replacing the “click”.

Finally, FIG. 5 shows a variant embodiment of the invention in which the shoulder 11 has been replaced by a conical surface 15 against which there comes to bear a complementary conical surface of the spacer 9 of the coupling. The spacer can be made of a transparent material that allows a sign carried on the surface 15 to be seen through the thickness of the material once sufficiently intimate contact has been achieved between said surface and the spacer, where such contact corresponds to the desired degree of tightening. It is also possible to provide a spacer made of a plastics material that changes color (e.g. by changing from transparent to opaque) once a certain degree of compression is achieved. In either case, the spacer acts as a visual indicator.

What is claimed is:

1. A junction between a first pneumatic element (1) having a hollow screw (3) of longitudinal axis (3a) and a second pneumatic element (2) provided with a tapped orifice (2a) for receiving the hollow screw (3), a first shoulder (5) of the hollow screw being provided for facing the edge (6) of the tapped orifice (2a), and an O-ring (7) being provided under the shoulder (5) to provide sealing between the first and second elements, wherein the first element (1) carries a bearing surface (8) at its end opposite from the thread, which bearing surface is terminated axially by a second shoulder (11), a tubular spacer (9) being slidably mounted on said bearing surface to slide between a first position in which it extends beyond the first shoulder (5) beside the thread, and a second position in which it is in contact with the second shoulder (11), the spacer including means (9a; 12) for indicating the tightening tension that has been established or that is to be established in the hollow screw (3).

2. A junction according to claim 1, wherein the bearing surface (8) possesses a peripheral portion in relief (10), and wherein the spacer (9) possesses a wall portion (9a) that is displaceable on going past the portion in relief.

3. A junction according to claim 2, wherein the displaceable wall portion (9a) is elastically deformable.

4. A junction according to claim 2, wherein the displaceable wall portion (9a) is breakable.

5. A junction according to claim 1, wherein the spacer (9) possesses a flattening zone which becomes flattened when it is axially compressed between the second shoulder (11) and the edge of the tapped orifice (2a).

6. A junction according to claim 5, wherein the above-mentioned flattening zone is constituted by portions in relief (14) at the end (13) of the spacer.

7. A junction according to claim 1, wherein at least one of the axial ends of the spacer (9) is provided with teeth suitable for biting into the second shoulder (11).

8. A junction according to claim 1, wherein the spacer is transparent or translucent.

9. A junction according to claim 1, wherein the spacer is held in its first position by axially-indexed connection means provided between the bearing surface and said spacer, which means are deactivated under the effect of an axial force applied against the spacer urging it towards the second shoulder.
